(19) United States
(12) Patent Application Publication
(10) Pub. No.: US 2005/0066996 A1
(43) Pub. Date: Mar. 31, 2005

(54) Stain-removal brush including cleaning composition dispenser

(75) Inventors: Paul Amaat Raymond Gerard France, West Chester, OH (US); Bradley Wayne Daubenspeck, West Chester, OH (US); Arne Benjamin Colman, Newark (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/937,003

(22) Filed: Sep. 9, 2004

Related U.S. Application Data
(63) Continuation-in-part of application No. 10/762,877, filed on Jan. 22, 2004.
(63) Continuation-in-part of application No. 10/659,868, filed on Sep. 11, 2003.
(60) Provisional application No. 60/546,896, filed on Feb. 23, 2004.
(60) Provisional application No. 60/441,689, filed on Jan. 22, 2003.
(60) Provisional application No. 60/409,861, filed on Sep. 11, 2002.

(51) Int. Cl. B08B 7/00

(52) U.S. Cl. 134/6; 15/29; 15/28

(57) ABSTRACT

A motorized stain-removal brush having a cleaning composition dispenser is provided. A method of using the motorized stain-removal brush for cleaning inanimate surfaces is also provided. The motorized stain-removal brush includes a handle having a motor disposed therein, a head having a longitudinal axis, and a neck disposed between the handle and the head. Bristle holders are associated with the head. The motor is operatively connected to the bristle holder.

### CROSS REFERENCE TO RELATED APPLICATIONS

This application claims the benefit of U.S. Provisional Application Ser. No. 60/546,896, filed on Feb. 23, 2004, and is a continuation-in-part of U.S. Ser. No. 10/762,877, filed on Jan. 22, 2004, which claims the benefit of U.S. Provisional Application Ser. No. 60/441,689 filed on Jan. 22, 2003, and is a continuation-in-part of U.S. Ser. No. 10/659,868 filed on Sep. 11, 2003, which claims the benefit of U.S. Provisional Application Ser. No. 60/409,861, filed Sep. 11, 2002.

### FIELD

The present invention relates to hand-held stain-removal brushes for inanimate surfaces. More specifically, the invention relates to hand-held motorized stain-removal brushes for fabrics and inanimate hard surfaces.

1. Background

One difficulty associated with stain-removal brushes that dispense cleaning compositions includes the tendency of the cleaning composition to drip and/or leak from the device after dispensing is concluded. The present invention addresses this drawback. This and other features, aspects, advantages, and variations of the present invention will become evident to those skilled in the art from a reading of the present disclosure with the appended claims and are covered within the scope of the claims.

2. Summary

The present invention is directed to an article of commerce and a method of cleaning inanimate surfaces. The article of commerce comprises:
a motorized stain-removal brush, wherein the motorized stain-removal brush comprises:
   i) a handle having a motor, pump, liquid transfer channel, and nozzle disposed therein wherein the nozzle opening includes a one way restriction valve;
   ii) a head having a longitudinal axis;
   iii) a neck disposed between the handle and the head;
   iv) a bristle holder associated with the head which oscillates or rotates;
   v) a set of bristles or a foam structure associated with the bristle holder;
   wherein the motor is operatively connected to the bristle holder.
   The one way restriction valve may be a check valve. The check valve may be a duckbill valve, umbrella check valve, poppet valve, flapper valve, needle valve, sphere valve, or a combination thereof. The nozzle opening may be adjacent to the bristle holder, disposed within the bristle holder, or a combination thereof.

The article may also include a reservoir for containing a cleaning composition. The reservoir may be attached to the handle.

The article of commerce may also include a set of instructions in association with the motorized stain-removal brush, wherein the instructions direct a user of the motorized stain-removal brush to put a solution in contact with the inanimate surface and use the motorized stain-removal brush to brush the solution on the inanimate surface.

### BRIEF DESCRIPTION OF THE DRAWINGS

It is believed that the present invention will be better understood from the following description taken in conjunction with the accompanying drawings in which:

FIG. 1 is a front view of a motorized stain-removal brush made in accordance with the present invention.

FIG. 2 is a side view of a motorized stain-removal brush of FIG. 1.

FIG. 3 is a rear view of the motorized stain-removal brush of FIG. 1.

FIG. 4 is an exploded perspective view of a motorized stain-removal brush made in accordance with the present invention.

FIG. 5 is a side view which shows cleaning efficiency angle.

FIG. 6 is a side view of a stain-removal brush bristle tuft pattern suitable for use with the motorized stain-removal brushes of FIGS. 1 to 4.

FIG. 7 is a side view of stain-removal brush head wherein a foam-like or sponge-like structure replaces the bristles suitable for use with the electric stain-removal brushes of FIGS. 1 to 4.

FIG. 8 is a perspective view of a device which can be used in conjunction with a tensile tester to measure cleaning efficiency angle.

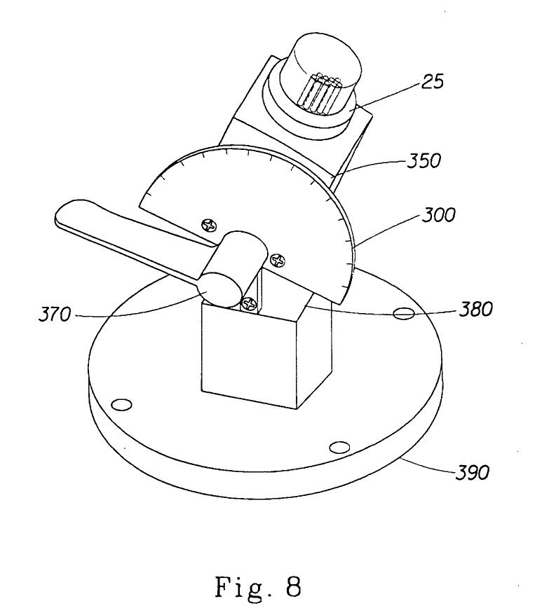

FIG. 9 is a perspective view of a reservoir which can be used in conjunction with the motorized stain-removal brush of the present invention.

FIG. 10 is a side cutaway view of a stain-removal brush made in accordance with the present invention.

### DETAILED DESCRIPTION

Reference will now be made in detail to various embodiments of the present invention, examples of which are illustrated in the accompanying drawings wherein like numerals indicate the same elements throughout the views. All percentages, ratios and proportions herein are on a weight basis unless otherwise indicated.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

As used herein, “inanimate surface” means a surface that does not make up a part of a living organism (e.g., does not include teeth). Examples of inanimate surfaces include, but are not limited to, fabrics and hard surfaces.

As used herein, “stain-removal brush” means a brush for cleaning an inanimate surface.

As used herein, “motorized” and “electric” are used interchangeably to refer to the use of power source to activate the stain-removal brush. Sources of power include but are not limited to batteries, plug-in electrical sources such as commonly used 110V and 220V current, solar power, and the like.

A. Stain-removal brush

As will be appreciated, the present invention is directed to electric stain-removal brushes (including electric stain-removal brushes having replaceable heads) and electric stain-removal brush heads having moving bristle holders. The bristle holder rotates or oscillates or reciprocates and translates, or performs any other non-rotational or oscillatory motion. Herein, the term “rotate” is intended to refer to a unidirectional angular motion (e.g., a constant clockwise motion) while the term “oscillate” is intended to refer to vibratory angular motion (e.g., repeated cycles of clockwise rotation and counter clockwise rotation). Vibration is any periodic movement having repeated cycles. Vibratory motion can have one or more frequencies and amplitudes. Vibratory motion that is substantially linear is referred to herein as a reciprocating motion.

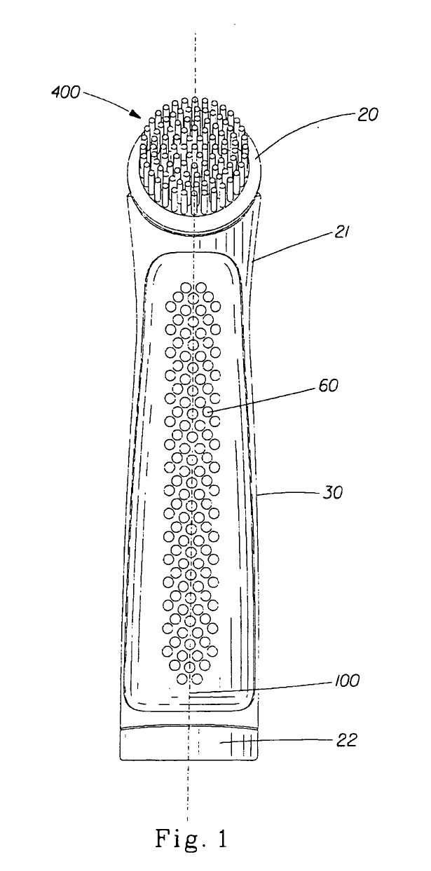

The present invention can be used in combination with electric stain-removal brushes and electric stain-removal brush heads that include shafts that rotate, oscillate, or reciprocate (as well as combinations thereof) to impart motion to the bristle holders. In addition, the present invention can be used in combination with electric stain-removal brushes and electric stain-removal brush heads where the shaft is operatively connected to the bristle holders. Referring to the Figures, some exemplary electric stain-removal brushes made in accordance with the present invention will now be described. These electric stain-removal brushes utilize a shaft that rotates or reciprocates. While these embodiments will be described with respect to the particular motor and shaft arrangement illustrated in FIG. 1 for purposes of simplicity and clarity, it will be appreciated that other motor and rotating (or oscillating) shaft arrangements can be substituted. For example, U.S. Pat. Nos. 5,617,603; 5,850,603; 5,974,615; 6,032,313; 5,732,432; 5,070,567; 5,170,525; 5,416,942; 3,588,936; 5,867,856; and 4,397,055, disclose other motor and rotating or oscillating shaft arrangements that might be suitable.

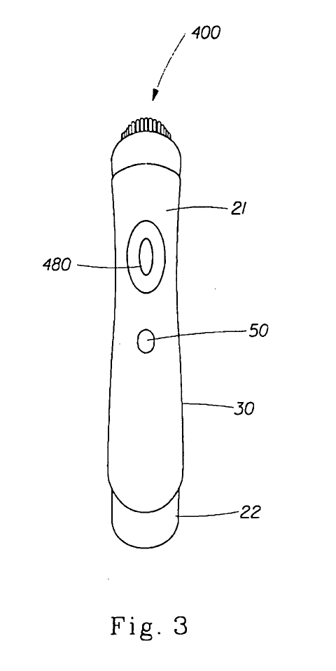

Turning to FIGS. 1 to 4, the electric stain-removal brush 400 comprises a stain-removal brush head 20, a body or handle 30, and a neck 21 there between. The term “longitudinal” is intended to refer to a lengthwise feature of an element as seen from a top planar view thereof. For example, as shown in FIG. 1, a longitudinal axis 100 is an axis passing through the longest dimension of an element, such as the head or a shaft. A longitudinal direction is a direction that generally corresponds to a longitudinal axis 100 but which may not lie in the same plane as the longitudinal axis 100. For example, the longitudinal axes 100 of a shaft and a stain-removal brush head may not lie in the same plane but generally extend in the same direction from a front view. Similarly, a neck and head that are angled with respect to each other may not have longitudinal axes that lie in the same plane, but do have axes that extend in the same general longitudinal direction from a front view. The electric stain-removal brushes of the present invention typically have a cylindrical head.

The handle 30 is hollow and includes a front housing 31, middle housing assembly 32, and upper housing 430. The front housing 31 might contain a profiled surface or dimples 60 to provide a better handle grip. The handle 30 also includes a motor 23, motor mount 93, motor holding plate 523, and electrical connector plate 524. The handle 30 may also include batteries 24, and a battery door 22 for powering the motor. A rechargeable power source can be substituted for the batteries. Additionally, other alternative power sources could be used including but not limited to plug-in electrical sources such as 110V and 220V current, solar power, and the like. Also shown is a battery door seal ring 27. A bristle holder 25 is disposed at the end of the handle 30. While the bristle holder 25 is illustrated as circular in shape, other shapes can be utilized. The bristle holder 25 may be replaceable and includes a connection system to easily attach to coupling head 80 at the remote-most end of the linkage system. The remote-most end of the linkage system may be bent or offset from the longitudinal axis 100 of the motor shaft, allowing the bristle holder 25 to be angled and not in the same plane as the motor shaft. In other words, the bristle holder 25 oscillates about an axis wherein the axis has a slight inclination angle.

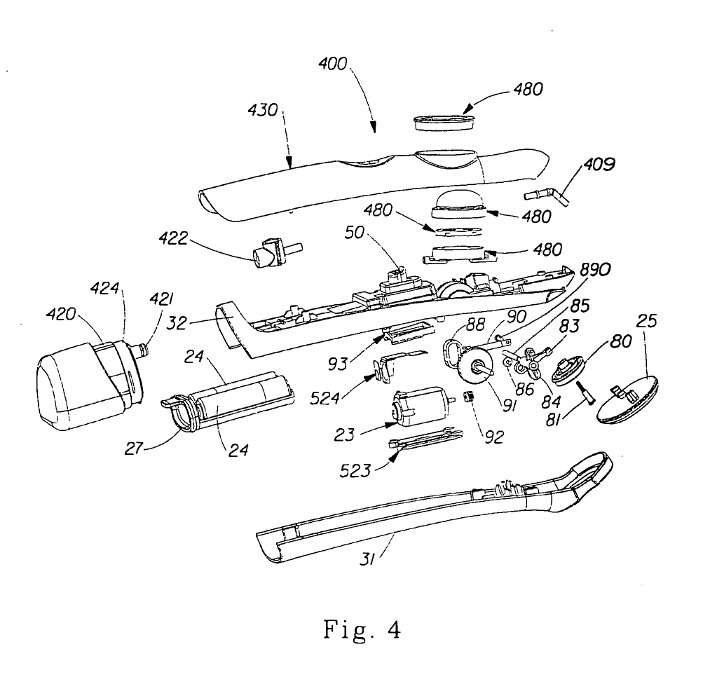

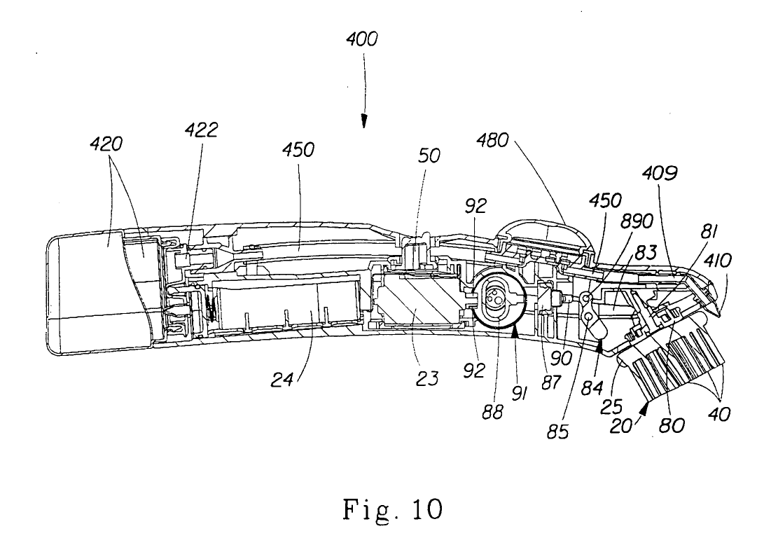

The stain-removal brush 400 may be provided with a replaceable head or a non-replaceable head. The motorized stain-removal brushes of the present invention utilize a shaft that reciprocates. While these embodiments will be described with respect to the particular motor and shaft arrangement illustrated in FIGS. 4 and 10, for purposes of simplicity and clarity, it will be appreciated that other motor and reciprocating shaft arrangements can be substituted.

Turning to FIGS. 1-7 and 10, the motorized stain-removal brush 400 comprises a stain-removal brush head 20, a body or handle 30, and an elongate neck 21 there between. The drive train, is comprised of the shafts and gears that transmit motion from the motor 23 to the coupling head 80 that connects with the replaceable bristle holder 25 (not shown) in a clip-on mode. While the coupling head 80 and the bristle holder are illustrated as circular in shape, other shapes can be utilized. The handle 30 is hollow. It consists of several compartments and includes a motor 23 and batteries 24 for powering the motor 23. The motor 23 is held in place in the rear housing assembly 32 handle by the motor-holding plate 523. In this embodiment, the coupling head 80 only oscillates and does not reciprocate, translate, or perform any other non-rotational or oscillatory motion.

A first gear (not shown) is operatively connected to and powered by the motor 23. A second gear or crown gear 91 is operatively connected to the first gear. The rotational axis of the second gear 91 is approximately normal to the rotational axis of the first gear such that the teeth of the first gear mesh with teeth of the second gear 91, thus causing second gear 91 to rotate as the first gear rotates.

A T-link arm 88 is eccentrically and pivotably connected to the second gear 91 via a pin 92 or other fastening device. Due to the eccentric connection, the rotational motion of the second gear 91 is converted into a reciprocating motion of the T-link arm 88 moving the T-link shaft 90. The T-link shaft 90 is fixedly secured, such as by a press fit into the T-link shaft 90 and linked to the V-link shaft 85 by pin 86 or other fastening device. The T-link shaft 90 is housed at least partially within the neck 21 and guided through a seal assembly 87. Referring to FIG. 4, the reciprocating T-link shaft 90 is connected at its terminal end by connector 890 to the V-link 84 which connects to the W-link 83 via pin 86 or other fastening device. The V-link 84 is supported by the V-link shaft 85. The terminal end of the W-link 83 connects to the coupling head 80. The W-link 83 is offset from the longitudinal axis of the T-link shaft 90 so that it is pinned (not shown) adjacent to the outer periphery of the coupling head 80. This offset arrangement converts the reciprocating motion of the W-link 83 into an oscillating motion of the coupling head 80. The coupling head 80 is connected to bristle holder 25 via coupling head shaft 81. The coupling head shaft 81 is received by rear housing 32.

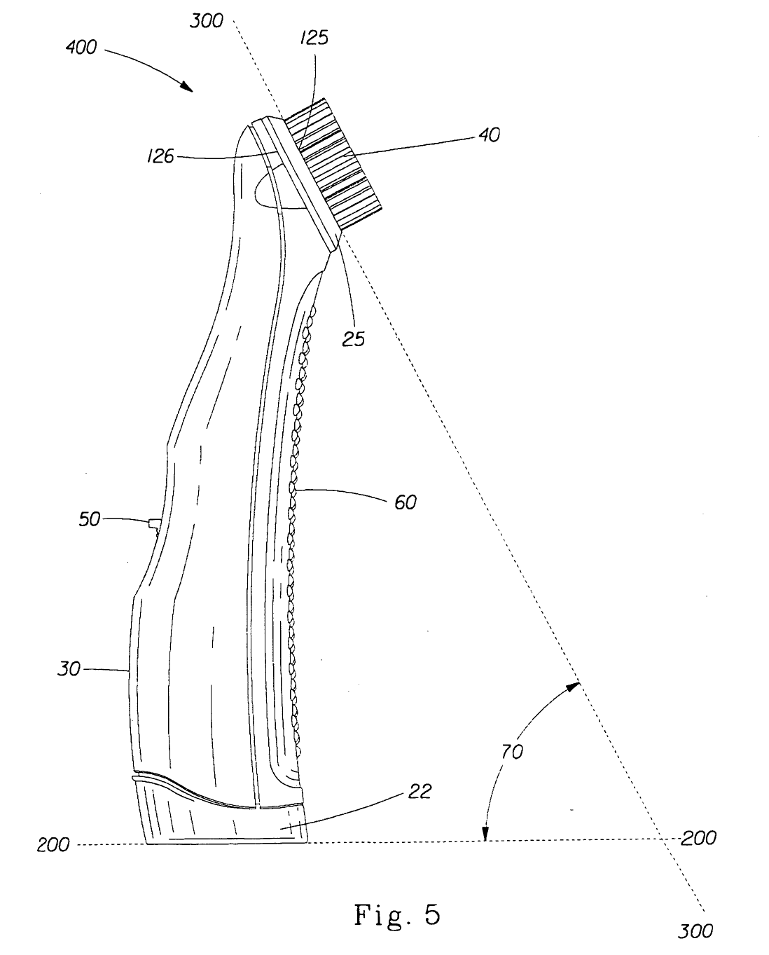

Referring to the non-limiting embodiment shown in FIG. 5, the stain-removal brush 400 may have a tilted or angled bristle holder 25 having a cleaning efficiency angle 70. The cleaning efficiency angle 70 may be between about 0 and 100 degrees, or between about 35 and 95 degrees, or between about 40 and 90 degrees. The cleaning efficiency angle 70 is measured at the intersection of line 200-200 with line 300-300, wherein line 200-200 is measured at the intersection of the x-axis of the bottom of the handle 30 and wherein line 300-300 is measured at the y-axis of the top surface 125 of the bristle holder 25. Should the bottom of the handle 30 be a non-planar surface, the line 200-200 would be measured from the point tangent to the bottom-most point of handle 30. Should the top surface 125 of the bristle holder 25 be non-planar, the line 300-300 would be measured from the point tangent to the upper-most point on top surface 125.

The bristle holder 25, which is generally cylindrical in shape, may have a diameter of between about 10 and 50 millimeters and preferably between about 20 and 40 millimeters. The distance between the top surface 125 of the bristle holder 25 and the bottom surface 126 of bristle holder 25 may be between about 2 and 15 millimeters. While embodiments of the present invention have been illustrated for simplicity with tufts of bristles that extend in a direction substantially perpendicular to the top surface of the bristle holders, it is contemplated that the bristles might be arranged differently to complement or further enhance the motions of the bristle holder. The bristle length may be between about 4 and 15 millimeters and preferably between about 6 and 13 millimeters. The bristle diameter may be between about 0.1 and 0.3 millimeters and preferably between about 0.15 and 0.2 millimeters.

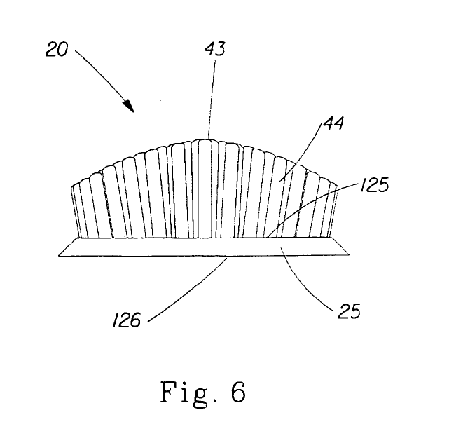

The electric stain-removal brushes of the present invention can be made with any combination of bristles, dimensions, combinations, angles and arrangements. One non-limiting embodiment is illustrated in FIG. 6. The bristle holder 25 has concentric rings of tufts. In one non-limiting embodiment there are tall tufts 43 and shorter tufts 44 forming a dome shaped brush head 20. The difference in length between the tall tufts 43 and the shorter tufts 44 is between about 0.5 mm and 5 mm in one embodiment and between about 1 mm and 3 mm in another embodiment.

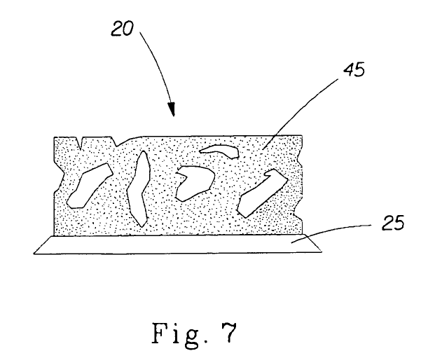

The bristles 40 can be provided with different characteristics, such as different heights (tall and short) as shown; and soft or firm. For example, soft bristles may be preferred for cleaning delicate fabrics (e.g., silk garments) and delicate hard surfaces (e.g., glass, plexiglass, compact discs, DVDs, gold plated surfaces, etc.). Alternatively, firmer bristles may be preferred for more rugged fabrics (e.g., denim, canvas, nylon, etc.) and most hard surfaces. Additionally, stiffer bristles typically require less force to be applied by the user, versus softer bristles. Less force applied by the user results in overall less stress on the user's fingers, hands, wrist arm and/or shoulder. In another embodiment, bristle tufts might be replaced in holder 25 by a sponge-like or foam structure 45 attached to the brush head 20 as shown in FIG. 7. Both bristles 40 and/or foam-like structures 45 may include different properties, non-limiting examples of which include antimicrobial properties and/or perfume ingredients.

In one non-limiting example the bristles may be made of Nylon 66 available from Tai Hing Nylon Filament Products Co., Ltd of Hong Kong. Examples of other suitable bristle materials include but are not limited to Nylon 6, Nylon 612, and polypropylene. The bristle diameter may be 6 mils and the bristle height may be 12 mm±0.25 mm. The total area of the bristle head may be approximately 93 cm². The bristle head may have a total of 94 tufts. Each tuft may consist of 34±4 bristles.

The bristle holder 25 oscillates at an angle of rotation between about 20 degrees and 45 degrees in one embodiment and between about 25 degrees and 35 degrees in another embodiment. The bristle holder has a peak oscillation frequency between about 1000 and about 10,000 cycles per minute in one embodiment and between about 2000 and 7000 cycles per minute in another embodiment. A cycle refers to one clockwise rotation to approximately 40 degrees and one counterclockwise rotation to approximately 40 degrees (or vice versa) when the batteries are fully charged. It is contemplated that the oscillation frequency may drop outside of these ranges as the batteries are drained by use.

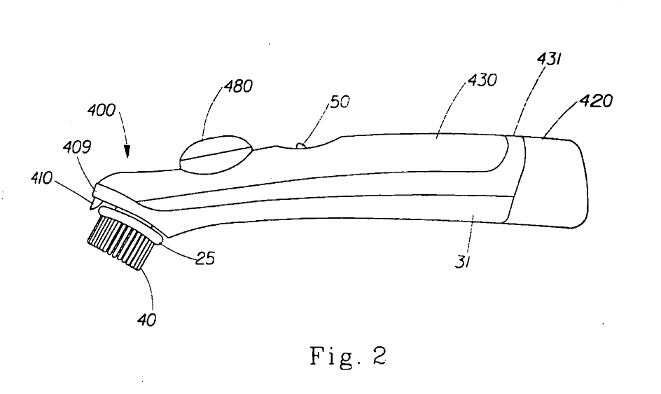

The stain-removal brush of the present invention may also dispense a cleaning composition. Referring to FIGS. 2-4 and 9-10, upper housing 430 has a hollow body for accommodating a pump 480, liquid transfer channel 450, and nozzle 409 having an opening containing a one-way restriction valve 410. More than one nozzle and/or more than one restriction valve may be used. The hollow body may also include one or more reservoirs 420 for containing a liquid.

The reservoir 420 may be detachable from the brush 400 and/or integral with the brush 400. In embodiments wherein the reservoir 420 is detachable from the brush 400, the reservoir 420 may be disposable such that when the reservoir 420 is empty, it may be detached from the brush 400 and disposed of. The reservoir 420 may be refillable. The reservoir 420 may include a recloseable opening. In embodiments wherein the reservoir 420 is detachable and/or refillable, it may be desirable for the reservoir 420 to stand on end for ease of access such as when refilling. The brush 400 can also include a cartridge for containing a cleaning composition. The cartridge may be attached to the brush 400 housing and/or the reservoir 420. For example, the cartridge could be connected to an opening in the brush 400 housing or to an opening in the reservoir 420. The cartridge can include a seal such that when fully engaged into the opening in the brush 400 housing or in the reservoir 420, the opening is sealably closed.

Referring to FIGS. 4, and 9-10, in one embodiment the brush 400 comprises at least one recess and/or protrusion 422 to fit into at least one corresponding protrusion and/or recess 421 of the reservoir 420 such that the reservoir 420 is releaseably secured in a leak-tight manner into the brush 400 such that fluid communication between the reservoir 420 and the brush 400 is established when the protrusion(s) and recess(es) are fitted into one another. Typically the protrusion(s) and recess(es) of the reservoir 420 will have complementary shapes with the protrusion(s) and recess(es) of the brush 400. Also the protrusion(s) and recess(es) 421 of the reservoir 420 may have exact complementary shapes with the protrusion(s) and recess(es) 422 of the brush 400. In instances where the shape of the reservoir may be such that it differs from that of the dispensing means, a fluid connection between the two may be established but it should be understood that the risk of leakage may be enhanced.

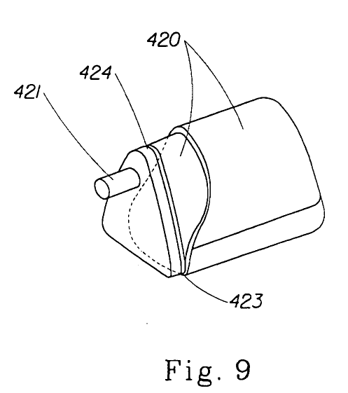

Referring to the non-limiting embodiment of FIG. 9, in addition to protrusion(s) and/or recess(es) 421, the reservoir 420, includes o-ring seal 423, an openable and closeable cap 424 attached to the reservoir 420. A dip tube (not shown) may also be included in the reservoir 420. The reservoir 420 may be located at the bottom of the brush 400 housing. The reservoir 420 can be made of any suitable material. Non-limiting examples of which include metal alloy, glass, and plastic. The reservoir 420 may be comprised of a transparent material such as PET. Generally the volume of the reservoir 420 is about 10-100 ml or about 30-50 ml. The reservoir 420 generally comprises one or more compartments. The compartment(s) will typically contain one or more cleaning compositions. Non-limiting examples of cleaning compositions which may be used with the present invention include but are not limited to water, surfactants, solvents, soil-release agents, wetting agents, preservatives, bleach, perfume, stain repellents, brighteners, color enhancers, softeners, wrinkle release agents, starch, sizing agents, deodorizers, and the like. Non-limiting examples of viscosities of the cleaning compositions are typically about 10,000 cps or less as measured at 25° C.

The reservoir 420 may be vented to allow for simultaneous admission of air back into the reservoir 420 to compensate for the loss of contents from the reservoir 420.

The cap 424 can have any suitable shape. It can be threaded, but can also be secured to the reservoir 420 by any other suitable means including but not limited to bayonet fitments, clips, and the like.

Referring to FIGS. 2-4 and 10, the pump assembly 480 may include a manually or electrically driven pump. Suitable electrically driven pumps include but are not limited to gear pumps, impeller pumps, piston pumps, screw pumps, peristaltic pumps, diaphragm pumps, or other miniature pump. Generally, the pump 480 is a manual pump having a flexible dome. When the dome is depressed (i.e.; activated), cleaning composition is pumped from the reservoir 420 through the liquid transfer channel 450 to the nozzle 409. The nozzle 409 may be adjacent to the bristle holder 25, disposed within the bristle holder 25, or a combination thereof.

In manual operation, in one non-limiting embodiment, a user activates the pump by depressing the dome. Non-limiting descriptions of manual pump systems suitable with the present invention are disclosed in U.S. Pat. No. 6,250,833 and U.S. Pat. No. 5,993,180. Generally, the pump 480 dispenses between about 0.5 ml to about 5 ml or about 1 ml to about 3 ml of liquid per activation. In one embodiment of the invention, the pump 480 is designed to be reversible such that it can dispense a liquid from the reservoir 420 as well as remove liquid from a surface and/or from the liquid transfer channel 450 back into either the same reservoir 420 or alternatively a different reservoir (not shown). It should be understood that the pump illustrated herein is for illustrative purposes and that there are many other pumping mechanisms familiar to those of ordinary skill in the art which are suitable for the present invention.

The liquid transfer channel 450 can be comprised of a conduit, non-limiting examples of which include tubing and metal pipe. The tubing can be flexible or rigid. Suitable non-limiting examples of materials of construction for the tubing and nozzle 409 include metal, rubber, and plastic. Non-limiting examples of materials of construction for the tubing include but are not limited to EVA, fluororesin (PFA), nylon or polyamide, polyethylene or PEX, polyolefin, polypropylene (PP), PTFE, polyurethane or urethane, PVC, PVDF, natural rubber, synthetic rubber, TYGON®, vinyl, and VITON®. Generally the inside diameter of the liquid transfer channel 450 ranges from about 0.5 mm to about 2 mm while the outside diameter ranges from about 1.5 mm to about 5.0 mm.

The one-way restriction valve 410 may be a check valve. The one-way restriction valve 410 prevents backflow of the cleaning composition. One suitable check valve is a duckbill valve. The duckbill valve is a flow sensitive variable area valve. At no flow conditions, the flaps of the valve remain closed. This prevents liquid from dripping from the nozzle opening. It also prevents the liquid transfer channel 450 from drying out. The duckbill valve is a flow sensitive variable area valve. As the pump is activated and the flowrate of the cleaning composition increases through the liquid transfer channel 450, pressure is exerted on the flaps of the duckbill valve and the valve opens more to accommodate this increased pressure. This type of valve allows for relatively high velocities to be achieved at small flowrates, thereby generating a desirable spray jet which can provide a self-cleaning effect. Hence, the duckbill design of the valve allows the valve to open with a small amount of inline pressure, which allows for potentially line clogging materials to be swept out of the liquid transfer channel 450. Suitable duckbill valves and check valves are available from Vernay Laboratories of Yellowsprings, Ohio. Non-limiting examples of suitable duckbill valves commercially available from Vernay Laboratories are model Nos. VA 3143, VA 3219, VA 3403, VA 4097, and VA 3272. Other suitable restriction valves which may be used include but are not limited to: umbrella check valves, poppet valves, flapper valves, needle valves, and sphere valves.

In one non-limiting embodiment of the present invention, a kit is provided which comprises the brush 400 and at least one reservoir 420 containing a product. The product can be a cleaning composition non-limiting examples of which are described above. The brush 400 may include at least two removable reservoirs 420. Each reservoir may contain a different product. The kit may further comprise an absorbent stain receiver article as described below.

The stain-removal brush aspect of the invention has been described with reference to particular embodiments. Modifications and alterations will occur to others upon reading and understanding this specification. It is intended that all such modifications and alterations are included insofar as they come within the scope of the appended claims or equivalents thereof.

B. Method of Use

The present invention also encompasses a method of using the stain-removal brush to clean inanimate surfaces. In one embodiment, the method comprises a) providing the electric stain-removal brush of the present invention, b) putting a solution in contact with an inanimate surface; and c) employing the electric stain-removal brush to brush the solution on the inanimate surface.

In another embodiment, the method comprises a) providing the electric stain-removal brush of the present invention, b) dispensing a solution from the stain-removal brush, and c) contacting an inanimate surface with the stain-removal brush and the solution.

The brush of the present invention is particularly useful for cleaning inanimate surfaces. For example, the stain-removal brush can be used alone or with additional laundry and stain pretreatment products (including but not limited to liquid and powder detergents, bleach, water, specialty pretreaters, and the like) to clean and remove stains from fabrics, particularly wearable fabrics. Fabrics include acrylic, cotton, lycra, polyester, rayon, spandex, washable silks with colorfast qualities, and wool, along with any blends of the above materials. The stain-removal brush can be used to apply products directly to the surface of the stain on the fabric via the bristles, or products can be directly applied to the stained fabric prior to using the device. The product can be dispensed from the stain-removal brush. The product can be dispensed from the brush through the bristles. The product can also be dispensed from the brush adjacent to the bristles. Alternatively, the product can be dispensed from the brush both through the bristles as well as adjacent to the bristles. Once the stain has been prepared and the operator has enabled the brush head 20 to rotate by actuating the power button 50, the stain-removal brush can be used to manually brush the surface of the stain on the fabric in any direction (circular, vertical, horizontal, diagonal, or any combination of the above). The stain-removal brush can also be used in the manner described above in a non-motorized or non-actuated mode.

Additional uses for the stain-removal brush include cleaning household fabrics such as upholstery, carpets, bedding, curtains, throw rugs, tablecloths, and other non-wearable fabrics in the same manner as listed above.

The stain-removal brush can also be used to clean inanimate hard surfaces, including those commonly found in a household (e.g., countertops, bathroom appliances, dishes, faucets, fixtures, floor baseboards, grout, kitchen appliances, shower doors, sinks, tile, toilets, tools, and tubs), shoe cleaning and polishing, car features (upholstery, cup holders, trim, detailing, car wheels, spokes) and jewelry.

Preferred hard surfaces include enamel surfaces. Herein, “enamel surface” means an inanimate surface being made of or coated with enamel. Herein “enamel” means titanium or zirconium white enamel or titanium or zirconium white powder enamel used as a coating for metal (e.g., steel) surfaces preferably to prevent corrosion of said metal surfaces. Enamel surfaces can typically be found in houses: e.g., in bathrooms or in kitchens, and include, e.g., bathrooms, fixtures and fittings sinks, showers, shower wash basins, tiles, tubs, and the like. Furthermore, cookware, dishes and the like may have an enamel surface. Enamel surfaces may also be found on household appliances which may be coated with enamel on their inside and/or outside surface including, but not limited to, automatic dryers, freezers, heating boiler, microwave ovens, conventional ovens, dishwashers refrigerators, washing machines, and so on. Further enamel surfaces may be found in industrial, architectural and the like applications. Examples of enamel surfaces found in said applications include enamel surfaces on or in architectural panels, chemical processing equipment, heat exchangers, hot water tanks, mechanical equipment, pipelines, pumps, reaction vessels, signs, silos, or tanks.

C. Self-Instructing Article of Commerce

The present invention also encompasses articles of commerce comprising 1) the electric stain-removal brush of the present invention, and 2) a set of instructions directing the user in the method of the present invention for cleaning an inanimate surface.

In a one embodiment, the article of commerce comprises the stain-removal brush of the present invention in association with a set of instructions, wherein the instructions direct the user to follow the method of cleaning an inanimate surface described above. For example, in one embodiment, such instructions would direct the user to 1) put a solution in contact with the inanimate surface to be cleaned, and 2) employ the electric stain-removal brush to brush the solution on the inanimate surface.

Herein, “in association with”, when referring to such instructions, means the instructions are either directly printed on the stain-removal brush; directly printed on the packaging for the stain-removal brush; printed on a label attached to the stain-removal brush; printed on a label attached to the packaging for the stain-removal brush; or presented in a different manner including, but not limited to, a brochure, print advertisement, electronic advertisement, broadcast or internet advertisements, and/or other media, so as to communicate the set of instructions to a consumer of the stain-removal brush.

The solutions employed in the present invention may be aqueous or non-aqueous. One non-limiting example of a non-aqueous solution is a lipophilic solution.

D. Aqueous Solution

As used herein, “aqueous solution” refers to a solution which contains water. The aqueous solution employed in the present invention may be any solution that facilitates the removal of a stain on an inanimate surface. In one embodiment, the aqueous solution comprises at least 10% water. In another embodiment the aqueous solution further comprises a surfactant.

Preferably, in embodiments involving the cleaning of fabrics, the aqueous solution is a liquid laundry detergent. In another embodiment for cleaning fabrics, the user may combine a granular laundry detergent with water to form a suitable aqueous solution.

Preferably, in embodiments involving the cleaning of hard surfaces, the aqueous solution is a liquid hard surface cleaner. In another embodiment for cleaning hard surfaces, the user may combine a granular hard surface cleaner with water to form a suitable aqueous solution.

In another embodiment, the aqueous solution further comprises a solvent. Solvents are particularly useful when cleaning a hard surface.

Additional non-limiting examples of aqueous solutions for use in the present invention may further comprise: ammonia, all-purpose cleaners, baking soda, bathroom/shower cleaners, bleach, car cleaners, and/or carpet cleaners.

In another embodiment, the aqueous solution further comprises particles. Such particles are particularly useful in facilitating mechanical disruption of a stain on the inanimate surface.

E. Lipophilic solution

The lipophilic solution employed in the present invention may be any non-aqueous solution that facilitates the removal of a stain on an inanimate surface and meets the requirements set forth in the Lipophilic Fluid Test (LF Test) as described below.

Qualification of Lipophilic Fluid—Lipophilic Fluid Test (LF Test)

Any non-aqueous fluid that is both capable of meeting known requirements for a stain removal fluid (e.g., flash point, etc.) and is capable of at least partially dissolving sebum, as indicated by the test method described below, is suitable as a lipophilic fluid herein. The ability of a particular material to remove sebum can be measured by any known technique. As a general guideline, perfluorobutylamine (Fluorinert FC-43®) on its own (with or without adjuncts) is a reference material that, by definition, is unsuitable as the lipophilic fluid herein (it is essentially a non-solvent) while cyclopentasiloxane (D5) dissolves sebum.

The following is the method for investigating and qualifying other materials, e.g., other low-viscosity, free-flowing silicones, for use as the lipophilic fluid. The method uses commercially available Crisco® canola oil, oleic acid (95% pure, available from Sigma Aldrich Co.) and squalene (99% pure, available from J. T. Baker) as model soils for sebum. The test materials should be substantially anhydrous and free from any added adjuncts, or other materials during evaluation.

Prepare three vials. Place 1.0 g of canola oil in the first; in a second vial place 1.0 g of the oleic acid (95%), and in a third and final vial place 1.0 g of the squalene (99%). To each vial add 1 g of the fluid to be tested for lipophilicity. Separately mix at room temperature and pressure each vial containing the lipophilic soil and the fluid to be tested for 20 seconds on a standard vortex mixer at maximum setting. Place vials on the bench and allow settling for 15 minutes at room temperature and pressure. If, upon standing, a single phase is formed in any of the vials containing lipophilic soils, then the fluid qualifies as suitable for use as a “lipophilic fluid” in accordance with the invention. However, if two or more separate layers are formed in all three vials, then the amount of fluid dissolved in the oil phase will need to be further determined before rejecting or accepting the fluid as qualified.

In such a case, with a syringe, carefully extract a 200 microliter sample from each layer in each vial. The syringe-extracted layer samples are placed in GC autosampler vials and subjected to conventional GC analysis after determining the retention time of calibration samples of each of the three models soils and the fluid being tested. If more than 1% of the test fluid by GC, preferably greater, is found to be present in any one of the layers which consists of the oleic acid, canola oil or squalene layer, then the test fluid is also qualified for use as a lipophilic fluid. If needed, the method can be further calibrated using heptacosafluorotributylamine, i.e., Fluorinert FC-43 (fail) and cyclopentasiloxane (pass).

A suitable GC is a Hewlett Packard Gas Chromatograph HP5890 Series II equipped with a split/splitless injector and FID. A suitable column used in determining the amount of lipophilic fluid present is a J & W Scientific capillary column DB-1HT, 30 meter, 0.25 mm id, 0.1 um film thickness cat# 1221131. The GC is suitably operated under the following conditions:
Carrier Gas: Hydrogen
Column Head Pressure: 9 psi
Flows: Column Flow @˜1.5 ml/min.
Split Vent @˜250-500 ml/min.
Septum Purge @˜1 ml/min.
Injection: HP 7673 Autosampler, 10 ul syringe, 1 ul injection
Injector Temperature: 350° C.
Detector Temperature: 380° C.
Oven Temperature Program: initial 60° C., hold 1 min.
rate 25° C./min.
final 380° C. hold 30 min.

Preferred lipophilic fluids suitable for use herein can further be qualified for use on the basis of having an excellent garment care profile. Garment care profile testing is well known in the art and involves testing a fluid to be qualified using a wide range of garment or fabric article components, including fabrics, threads and elastics used in seams, etc., and a range of buttons. Preferred lipophilic fluids for use herein have an excellent garment care profile, for example they have a good shrinkage or fabric puckering profile and do not appreciably damage plastic buttons.

For purposes of garment care testing or other qualification, e.g., flammability, a lipophilic fluid for use in the lipophilic fluid can be present in a mixture, e.g., with water, at approximately the ratio to be used in the final lipophilic fluid which will come into contact with fabric articles. Certain materials, which remove sebum, qualify for use as lipophilic fluids; for example, ethyl lactates can be quite objectionable in their tendency to dissolve buttons, and if such a material is to be used in the lipophilic fluid, it will be formulated with water and/or other solvents such that the overall mix is not substantially damaging to buttons. Other lipophilic fluids, D5 for example, meet the garment care requirements commendably. Some suitable lipophilic fluids may be found in granted U.S. Pat. Nos., 5,865,852; 5,942,007; 6,042,617; 6,042,618; 6,056,789; 6,059,845; and 6,063,135.

Lipophilic solvents can include linear and cyclic polysiloxanes, hydrocarbons and chlorinated hydrocarbons. More preferred are the linear and cyclic polysiloxanes and hydrocarbons of the glycol ether, acetate ester, lactate ester families. Preferred lipophilic solvents include cyclic siloxanes having a boiling point at 760 mm Hg. of below about 250° C. Specifically preferred cyclic siloxanes for use in this invention are octamethylcyclotetrasiloxane, decamethylcyclopentasiloxane, and dodecamethylcyclohexasiloxane. It should be understood that useful cyclic siloxane mixtures might contain, in addition to the preferred cyclic siloxanes, minor amounts of other cyclic siloxanes including hexamethylcyclotrisiloxane or higher cyclics such as tetradecamethylcycloheptasiloxane. Generally the amount of these other cyclic siloxanes in useful cyclic siloxane mixtures will be less than about 10 percent based on the total weight of the mixture.

F. Absorbent Stain Receiver Article

In another embodiment, the stain-removal brush and cleaning solution is used in combination with an Absorbent Stain Receiver Article (“ASRA”). The ASRA herein can comprise any of a number of absorbent structures which provide a capillary pressure difference through their thickness (Z-direction). When designing the ASRA for use in the spot removal process herein, the following matters are taken into consideration. First, the cleaning solution only removes the soil from the fibers of the fabric even with agitation. If the cleaning solution which carries the soil is allowed to remain in the fabric, the soil will be redeposited on the fabric as the cleaning solution dries. The more complete the removal of cleaning solution from the fabric, the more complete will be the removal of soil.

Second, the fabric being treated is, itself, basically a fibrous absorbent structure which holds liquid (i.e., the cleaning solution) in capillaries between the fibers. While some liquid may be absorbed into the fibers, most of the liquid will be held in interfiber capillaries (this includes capillaries between filaments twisted into a thread). Liquid held in the fabric may be removed by contacting it with another absorbent structure such as the ASRA, herein. In this process, liquid is transferred from the capillaries of the fabric to the capillaries of the ASRA. Third, liquid is held in capillaries by capillary pressure. Capillary pressure (Pc) is generally described by the following equation:
Pc=(2×G×Cos A)/R
where
G=the surface tension of the liquid
A=the contact angle between the liquid and the capillary wall
R=the radius of the capillary
   Accordingly, capillary pressure is highest in capillaries which have a low contact angle and a small radius. Liquid is held most tightly by high capillary pressure and will move from areas of low capillary pressure to areas of high capillary pressure. Hence, in the subject ASRA which provides a capillary pressure difference through its thickness, liquid will move from low capillary pressure areas to high capillary pressure areas. Capillary pressure can be measured using a variety of techniques, but will employ the liquid cleaning composition as the test liquid.

In reality, most absorbent materials are complex structures comprised of a range of capillary sizes and contact angles. For this discussion, the capillary pressure of a material or capillary pressure zone within a material is defined as the volumetric weighted average of the range of pressures found within that material or zone.

For purposes of illustration, in circumstances wherein a soiled fabric saturated with cleaning solution is in liquid communication contact with two stacked, identical layers of homogeneous absorbent material, such as a paper towel, solution and soil would readily transfer from the fabric to the towel until the capillary pressure is approximately equal in the two materials. At equilibrium a certain amount of solution and soil will remain in the fabric. The exact amount will depend on the basis weight and capillary pressure characteristics of the fabric and towel. A reduced amount of residual solution and soil in the fabric, and therefore better cleaning, would result from replacing the bottom layer (layer not in direct contact with the fabric) of towel with an absorbent layer of capillary pressure higher than that of the towel. By virtue of its higher capillary pressure this absorbent layer will cause more solution to transfer from the low capillary pressure top towel layer to the high capillary pressure absorbent layer which in turn causes more solution to transfer from the fabric to the top towel layer. The result is better cleaning due to less residual solution and soil remaining in the fabric.

This type of multi-layer system is also beneficial when Z-directional pressure is applied to the wetted stained fabric and ASRA. This pressure compresses the various materials, thereby lowering their void volume and liquid absorption capacity (increasing the % saturation of the materials). This can cause liquid to be squeezed out. The layered structure allows for free liquid to be absorbed by the lower layer, i.e., the one furthest away from the fabric. This lessens the reabsorption of liquid by the fabric. This is especially true if the bottom layer (layer of highest capillary pressure) is also relatively incompressible (retains a higher percentage of its void volume under pressure) compared to the top layer (layer of lower capillary pressure). In this case it may be desirable for the top layer to be resiliently compressible so as to express liquid under pressure which can be absorbed by the bottom layer.

Thus the ASRA can comprise two or more relatively distinct layers which differ in capillary pressure. As can be seen from the capillary pressure equation, a difference in capillary pressure can be achieved by varying the capillary size or the contact angle between the cleaning solution and the ASRA. Both factors can be controlled by the composition of the ASRA. The contact angle portion of the equation can also be affected by chemical treatment of the ASRA with, for example, a surfactant to lower the contact angle or a water repellent material such as silicone to increase contact angle.

The effectiveness of an ASRA comprising multiple layers of differing capillary pressure can be enhanced by locating most of the total absorbent capacity in the high capillary pressure portion. The top fabric facing layer need only be thick enough to insulate the fabric from the liquid held in the bottom layer.

The effectiveness of the layered ASRA can be further enhanced by selecting the low capillary pressure portion to have a capillary pressure higher than that of the fabric being treated.

In an ASRA comprised of two or more layers differing in capillary pressure, the pattern of capillary pressure change can be characterized as “stepped”. Through the thickness of the ASRA there is a sharp change or step in capillary pressure at the layer interfaces. It will be appreciated that the ASRA herein need not comprise multiple distinct layers, but rather can comprise a single layer structure with a relatively continuous capillary size gradient through its thickness.

Fibers—The ASRA can be made from a variety of materials including fibrous absorbents and foams. Useful fibrous absorbents include nonwoven fabrics (carded, hydroentangled, thermal bonded, latex bonded, meltblown, spun, etc.), thermal bonded airlaid nonwovens (“TBAL”), latex bonded airlaid nonwovens (“LBAL”), multi-bonded airlaid nonwovens (“MBAL” combined latex and thermal bonded), wet laid paper, woven fabrics, knitted fabrics or combination of materials (i.e., top layer of a carded nonwoven, and a bottom layer of wet laid paper). These fibrous absorbents can be manufactured using a wide variety of fibers including both natural and synthetic fibers. Useful fibers include wood pulp, rayon, cotton, cotton linters, polyester, polyethylene, polypropylene, acrylic, nylon, multi-component binder fibers, etc. Multiple fiber types can be blended together to make useful materials. Useful foam materials include polyurethane foams and high internal phase emulsion foams. The critical factor is to have a difference in capillary pressure within the thickness of the ASRA. A broad range of fiber sizes can be employed. A typical, but non-limiting range of diameters is from about 0.5 micrometers to about 60 micrometers. For meltblown, the preferred fibers are less than about 10 micrometers. Typical spun-bond and synthetic staple fibers range in diameter from about 14 to about 60 micrometers. In general, one selects smaller diameter fibers for the high capillary pressure layer and higher diameters for low capillary pressure. Fiber length can depend on the forming process that is being used and the desired capillary pressure. Spun-bonds comprise a substantially continuous fiber. For air-laid fibers, 4-6 mm is typical. For carded fibers the range is typically 25-100 mm. In addition, it has now been found that enriching the upper layer in bicomponent fibers decreases Tinting during use. Cleaning can also be enhanced by making the top layer rich in synthetic (e.g., bicomponent) fibers due to their lipophilic nature which aids in the removal of oily stains from the fabric being treated.

Absorbent gelling materials (“AGM”) such as those sometimes referred to in the diaper art as ‘supersorbers’ can be added to either or both layers of the receiver or as a discrete layer between the fiber layers or on the back of the bottom layer of the ASRA. Functionally, the AGM provides additional liquid absorption capacity and serves to drain the capillaries in the ASRA structure which helps to maintain the capillary pressure gradient as liquid is absorbed.

In light of the foregoing considerations, the ASRA herein can be defined as an absorbent structure which has a capillary pressure difference through its thickness (Z-direction). In a typical, but non-limiting mode, this can be achieved by having relatively larger capillaries (for example 50-100 micrometers radius) in the upper, liquid-receiving portion of the ASRA which is placed in contact with the fabric being treated. The lower, liquid-storage portion having relatively smaller capillaries (for example 5-30 micrometers radius). Irrespective of the size employed, it is desirable that the difference in average capillary pressure between the two layers be large enough that the overlap in capillary pressure range between the two layers is minimized.

Basis Weight—The basis weight of the ASRA can vary depending on the amount of cleaning solution which must be absorbed. A preferred 127 mm×127 mm receiver absorbs about 10-50 grams of water. Since very little liquid is used in the typical stain removal process, much less capacity is actually required. A typical TBAL ASRA pad weighs about 4-6 grams. A useful range is therefore about 1 gram to about 7 grams. A variety of sizes can be used, e.g., 90 mm×140 mm.

Size—The preferred size of the ASRA is about 127 mm×127 mm, but other sizes can be used, e.g., 90 mm×140 mm. The shape can also be varied.

Thickness—The overall thickness of the preferred ASRA is about 3 mm (120 mils) but can be varied widely. The low end may be limited by the desire to provide absorbency impression. A reasonable range is 25 mils to 200 mils.

Lint Control Binder Spray—The ASRA is preferably dust free. Some materials are naturally dust free (synthetic nonwoven fabrics). Some, generally cellulose containing materials, can be dusty because not all the fibers are bonded. Dust can be reduced by bonding substantially all the fibers which reside on or near the surface of the ASRA which contacts the fabric being treated. This can be accomplished by applying resins such as latex, starch, polyvinyl alcohol or the like. Cold or hot crimping, sonic bonding, heat bonding and/or stitching may also be used along all edges of the receiver to further reduce Tinting tendency.

Backing Sheet—The ASRA is generally sufficiently robust that it can be used as-is. However, in order to prevent strike-through of the liquid onto the table top or other treatment surface selected by the user, it is preferred to affix a liquid-impermeable barrier sheet to the bottom-most surface of the lower layer. This backing sheet also improves the integrity of the overall article. The bottom-most layer can be extrusion coated with an 0.5-2.0 mil, preferably 1.0 mil, layer of polyethylene or polypropylene film using conventional procedures. A film layer could also be adhesively or thermally laminated to the bottom layer. The film layer is designed to be a pinhole-free barrier to prevent any undesired leakage of the cleaning composition beyond the receiver. This backing sheet can be printed with usage instruction, embossed and/or decorated, according to the desires of the formulator. The ASRA is intended for use outside the dryer. However, since the receiver may inadvertently be placed in the dryer and subjected to high temperatures, it is preferred that the backing sheet be made of a heat resistant film such as polypropylene or nylon.

Colors—White is the preferred color for the ASRA as it allows the user to observe transfer of the stain from the fabric to the receiver. However, there is no functional limit to the choice of color. The backing sheet can optionally be a contrasting color.

Embossing—The ASRA can also be embossed with any desired pattern or logo.

Manufacture—A typical, but non-limiting, embodiment of the ASRA herein is a TBAL material which consists of an upper, low capillary pressure layer which is placed in liquid communication contact with the fabric being treated and a bottom high capillary pressure layer. The ASRA can be conveniently manufactured using procedures known in the art for manufacturing TBAL materials; see U.S. Pat. No. 4,640,810. As an overall proposition, TBAL manufacturing processes typically comprise laying-down a web of absorbent fibers, such as relatively short (24 mm) wood pulp fibers, in which are commingled relatively long (4-6 mm) bi-component fibers. The sheath of the bicomponent fiber melts with the application of heat to achieve thermal bonding. The bi-component fibers intermingled throughout the wood pulp fibers thereby act to ‘glue’ the entire mat together. Both layers in one embodiment of the ASRA herein can be a homogeneous blend of wood pulp fibers and bi-component thermal bonding fibers. In a more preferred embodiment, the top layer is 100% concentric bi-component fiber comprising 50:50 (wt.) polyethylene (PE) and polypropylene (PP) comprising a PP core enrobed in an outer sheath of PE. The gradient is achieved by providing a higher proportion of bicomponent bonding fibers in the top layer compared to the bottom layer. Using a TBAL process as described in U.S. Pat. No. 4,640,810, the top, low capillary pressure layer is formed by a first forming station from 100% bicomponent fiber (AL-Thermal-C, 1.7 dtex, 6 mm long available from Danaklon a/s). Basis weight of this all-bicomponent top layer is approximately 30 gsm (grams/meter²). The bottom, high capillary pressure layer is formed upon the top layer by second and third forming stations from a fiber blend consisting of approximately 72% wood pulp (Flint River Fluff available from Weyerhaeuser Co.) and approximately 28% bi-component binder fiber. Basis weight of this bottom layer is approximately 270 gsm. Each of the second and third forming station deposits approximately half of the total weight of the bottom layer. The two layers are then calendered to provide a final combined thickness of approximately 3 mm. Subsequently, a 1.0 mil coating of polypropylene is extrusion coated onto the exposed surface of the bottom layer. Individual receivers are cut to 127 mm×127 mm size. In one optional mode, since the material will be wound into a roll before applying the back sheet, a binder (e.g., latex—Airflex 124 available from Air Products) can be applied to the exposed surface of the lower layer prior to thermal bonding to prevent transfer of dust to the top all-bicomponent layer. Alternatively, a non-linting sheet can be placed on the ASRA during roll-up to prevent linting due to contact between the surfaces.

The composition and basis weights of the layers can be varied while still providing an ASRA with the desired capillary pressure gradient and cleaning performance.

G. Method of Measuring Cleaning Efficiency Angle

This provides a method which may be used to measure the cleaning efficiency angle. An instrument for measuring tensile strength may be used. A non-limiting example of a suitable instrument is an Instron Model #8511 manufactured by Instron, Inc. of Canton, Mass. Referring to FIG. 10, the bristle holder 25 is mounted onto a plastic block 350. A protractor 300 having angular degree gradations is mounted onto the plastic block 350. The protractor 300 and plastic block 350 are attached to one another with pivot arm 370. The protractor 300, plastic block 350, and pivot arm 370 are attached to a base 380. The base 380 is attached to mounting bracket 390. The mounting bracket is available from Instron, Inc. The protractor 300 and plastic block 350 may be pivoted in relation to base 380 and mounting bracket 390 to the desired angle. The mounting bracket 390 is then mounted onto the tensile tester such that the center point of the bristle holder 25 is aligned with the load cell center line. The force reading from the load cell is set to the 200 pound range. The displacement rate is 0.5 inches per minute. Rest at full displacement is 0.5 seconds.

### EXAMPLE

The method described above may be used to measure cleaning efficiency angle. An Instron Model #8511 can be used utilizing the Instron displacement program referred to as “trapezoid”. A force reading from the Instron load cell is 200 pound range. The force and displacement can be monitored at Nicolet Pro 20 o-scope. For each test increment the angle of brush engagement is set. Tests are run at 2.5 degree increments both to the right and to the left. Top dynamic faceplate is manually lowered from non-engagement position (zero) to point of full brush bristle face engagement. This is total test displacement. This point becomes test stop, rest and return. Dynamic faceplate is returned to zero position. Full brush engagement is experienced when all bristles actually engage the top faceplate. Nicolet is calibrated against a 5 pound weight and programmed to provide displacement in inches (channel 1) and force in pounds (channel 2). The Nicolet is triggered at displacement curve. The Nicolet curves are against time in seconds. At the start of the test, the dynamic face plate is lowered to engage the brush at 0.5 inches per second to the point of full brush face engagement. There is a rest for 0.5 seconds and then a return to the zero displacement point at 0.5 inches per second. This cycle is repeated at least once to for repeatability purposes. At the Nicolet, the engagement point between the dynamic faceplate and the first bristle plane is determined. This point and the total test displacement difference determines full bristle engagement displacement. At the Nicolet, the engagement point at first bristle contact (zero force) and total test displacement determines the reported force at full bristle engagement. This is a dynamic force reading. The static force reading occurs at the 0.5 second rest. The static force reading will be slightly higher than the dynamic force reading.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

1. A method of cleaning an inanimate surface comprising:
a) providing a motorized stain-removal brush, wherein the motorized stain-removal brush comprises:
i) a handle having a motor, pump, liquid transfer channel, and nozzle disposed therein wherein the nozzle opening includes a one-way restriction valve;
ii) a head having a longitudinal axis;
iii) a neck disposed between the handle and the head;
iv) a bristle holder associated with the head which oscillates or rotates;
v) a set of bristles or a foam structure associated with the bristle holder wherein the motor is operatively connected to bristle holder;
b) dispensing a solution from the stain-removal brush; and
c) contacting the solution and the electric stain-removal brush to the inanimate surface.

2. The method of claim 1 wherein the motorized stain-removal brush further comprises a reservoir wherein the reservoir includes the solution dispensed from the stain-removal brush.

3. The method of claim 1 further comprising the step of:
providing an absorbent stain receiver article which contacts the inanimate surface treated with the solution with the absorbent stain receiver article.

4. The method of claim 1, wherein the tilted bristle holder oscillates at a frequency of between about 1000 and 10,000 cycles per minutes.

5. The method of claim 1, wherein the bristle holder has a circular shape with a diameter of between about 10 and 50 mm.

6. The method of claim 1, wherein the bristles have a length of between about 5 and 15 mm.

7. The method of claim 1, wherein the bristles have a diameter of between about 0.1 and 0.3 mm.

8. The method of claim 1, wherein the solution is an aqueous solution.

9. The method of claim 1 wherein the solution is dispensed from the stain-removal brush adjacent to the bristle holder.

10. The method of claim 1, wherein the one-way restriction valve comprises a check valve.

11. The method of claim 10, wherein the check valve is a duckbill valve, umbrella check valve, poppet valve, flapper valve, needle valve, sphere valve, or a combination thereof.

12. The method of claim 11 wherein the check valve is a duckbill valve.

13. An article of commerce comprising:
a) a motorized stain-removal brush, wherein the motorized stain-removal brush comprises:
i) a handle having a motor, pump, liquid transfer channel, and nozzle disposed therein wherein the nozzle opening includes a one-way restriction valve;
ii) a head having a longitudinal axis;
iii) a neck disposed between the handle and the head;
iv) a bristle holder associated with the head which oscillates or rotates; and
v) a set of bristles or a foam structure associated with the bristle holder;
wherein the motor is operatively connected to the bristle holder.

14. The article of commerce of claim 13 wherein the nozzle is located adjacent to the bristle holder.

15. The article of commerce of claim 13 wherein the nozzle is disposed within the bristle holder.

16. The article of commerce of claim 13 wherein the one-way restriction valve is a check valve.

17. The article of commerce of claim 16 wherein the check valve is a duckbill valve, umbrella check valve, poppet valve, flapper valve, needle valve, sphere valve, or a combination thereof.

18. The article of commerce of claim 17 wherein the check valve is a duckbill valve.

19. The article of claim 13 further comprising a set of instructions in association with the motorized stain-removal brush, wherein the instructions direct a user of the electric stain-removal brush to:
i) dispense a solution from the motorized stain-removal brush, and
ii) contact the solution and the motorized stain-removal brush to the inanimate surface.

20. A kit, the kit comprising:
a) a motorized stain-removal brush, wherein the motorized stain-removal brush comprises:
i) a handle having a motor, pump, liquid transfer channel, and nozzle disposed therein wherein the nozzle opening includes a one-way restriction valve;
ii) a head having a longitudinal axis;
iii) a neck disposed between the handle and the head;
iv) a bristle holder associated with the head which oscillates or rotates; and
v) a set of bristles or a foam structure associated with the bristle holder;
wherein the motor is operatively connected to the bristle holder; and
b) at least one reservoir capable of being removeably attached to the brush wherein the reservoir contains product.
